(19) United States
(12) Patent Application Publication
(10) Pub. No.: US 2024/0395483 A1
(43) Pub. Date: Nov. 28, 2024

(54) SAFETY APPARATUS, SYSTEM AND PROCESS

(71) Applicant: PIZZATO ELETTRICA S.R.L., Marostica (IT)

(72) Inventor: Marco PIZZATO, Marostica (IT)

(21) Appl. No.: 18/670,793

(22) Filed: May 22, 2024

(30) Foreign Application Priority Data
May 22, 2023 (IT) 102023000010353

(51) Int. Cl. H01H 27/00; H01H 3/02; H01H 3/16

(52) U.S. Cl. CPC H01H 27/007; H01H 3/163; H01H 2003/024

(57) ABSTRACT

Safety apparatus comprising a safety switch and an actuator designed to be associated with a movable guard and to interact with each other upon the opening and closing of said movable guard. The safety switch comprises switching means designed to turn between an active state and an inactive state, a locking mechanism for locking the actuator in contact with the safety switch, a control unit connected to the locking mechanism and to the switching means for controlling the same. The safety switch also comprises a main reset member for transmitting a main reset signal to the control unit.

### TECHNICAL FIELD

The present invention refers to a safety apparatus suitable for industrial automation, in particular for controlling of the accesses inside a safety perimeter of a machine or an industrial plant. The present invention also refers to a safety system comprising the safety apparatus and the operating process thereof.

### STATE OF THE ART

In the industrial automation sector, it is known to enclose a machine or system characterized by dangerous operation with mechanical barriers for preventing the operator from coming into contact with the machine during its operation.

It is also known that, occasionally, an operator needs to be allowed to access the enclosed machine for process or maintenance needs, or other similar needs. For this reason, usually, the mechanical barriers enclosing the machine are equipped with a movable guard, for example a door or a hatch, which allow an operator to enter the fenced area and operate on the machine.

The movable guard is normally associated with a safety switch, also known as an “interlocking device”, which detects the state thereof, i.e. whether the movable guard is open, closed or locked, and safely signals this state to a control device. Therefore, the control device, such as a PLC or a safety module, controls the power supply to the machine according to the state of the movable guard. Usually, the control device only allows the machine to be started when it detects that the movable guard is closed and locked.

In some cases, however, to allow the machine to be restarted, both the movable guard must be closed and locked and the operator must signal that he has actually left the fenced area.

To allow this, some known systems, such as the system described in EP3922898, comprise, in addition to the safety switch, also a pushbutton panel independent of it and provided with a reset (or acknowledgment) button and a control unit. In these cases, the control unit of the pushbutton panel is connected to the safety switch to control its operation and receive information relating to the status of the movable guard. Furthermore, the control unit of the pushbutton panel is also connected to the control device, the PLC, to transmit a safety signal thereto that allows the machine to be restarted. In particular, this safety signal is transmitted when the control unit detects, via the safety switch, that the movable guard is closed and locked and when its reset button is pressed.

Although used, this solution has some drawbacks.

A first drawbacks consists in the fact that the control unit of the pushbutton panel should manage the signals transmitted safely by the safety switch. To this aim, the control unit of the pushbutton panel has to be equipped with a safety architecture, for example redundant with dual-channel, with a consequent increase in its production and installation costs.

Another drawback consists in the fact that for the preparation of known systems it is necessary to connect the pushbutton panel both to the safety switch and to the control device. This involves a very laborious, expensive and normally time-consuming installation. Furthermore, such installation requires many manual steps that lend themselves to human error that could compromise the safety of the machine operator.

### SCOPE OF THE INVENTION

An object of the present invention is to realize an economical and compact safety apparatus which at the same time allows to signal both that a movable guard is closed and locked and that an operator has left the fenced area.

Another object of the present invention is to realize a safety apparatus that can be installed simply and in a shorter time than that required for known solutions.

A further object of the present invention is to realize a safety device that is simple to use for an operator and which makes the operations for restarting the machine simpler.

### BRIEF DISCLOSURE OF THE DRAWINGS

FIGS. 1 and 3 are schematic views of a safety apparatus according to respective embodiments of the present invention, in a condition of use;

FIGS. 2 and 4 are, respectively, simplified representations of the electrical connection diagram of the safety apparatus of FIGS. 1 and 3;

FIGS. 5 and 6 are, respectively, simplified representations of the electrical diagram of a part of the safety apparatus of FIGS. 1 and 3;

FIGS. 7 and 8 are axonometric views of part of the safety apparatus of the present invention according two embodiments;

FIGS. 9 and 10 are schematic sectional views of the part of the safety apparatus in FIGS. 7 and 8;

FIGS. 11 to 14 are flow diagrams of the process according to the present invention.

### BEST MODES OF CARRYING OUT THE INVENTIONS

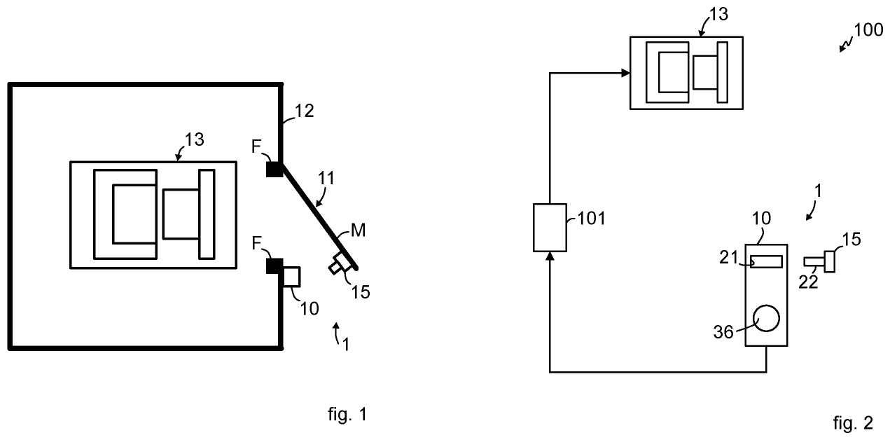

With reference to FIGS. 1 and 3, a safety apparatus 1 according to the present invention comprises a safety switch 10 designed to be associated with a movable guard 11 of a mechanical barrier 12 to protect a machine or industrial plant 13, hereinafter referred only as machine 13.

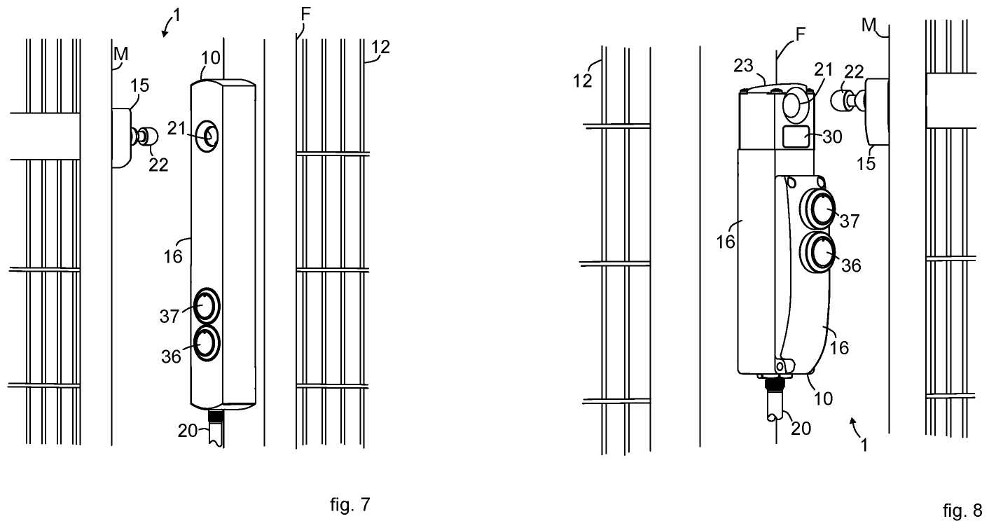

By way of example, the movable guard 11 may be a door, of any type such as a hinged, sliding or other type door, a door, a gate, a lid, a cover, a cap, a shutter or more. The movable guard 11 comprises a fixed part F (FIGS. 7 and 8), for example a frame, and a movable part M which is movable with respect to the fixed part F between an open position wherein it allows at least partial access of an operator inside the area delimited by the mechanical barrier 12 and a closed position wherein it does not allow the operator to access inside the area delimited by the mechanical barrier 12.

The safety apparatus 1 also comprises an actuator 15 designed to interact with the safety switch 10 upon the opening and closing of the movable guard 11. In particular, the safety switch 10 is suitable to be fixed to one between the fixed part F and the movable part M and the actuator 15 is suitable to be fixed to the other between the fixed part F and the movable part M.

In the examples given here, the safety switch 10 is fixed to the fixed part F and the actuator 15 is fixed to the movable part M.

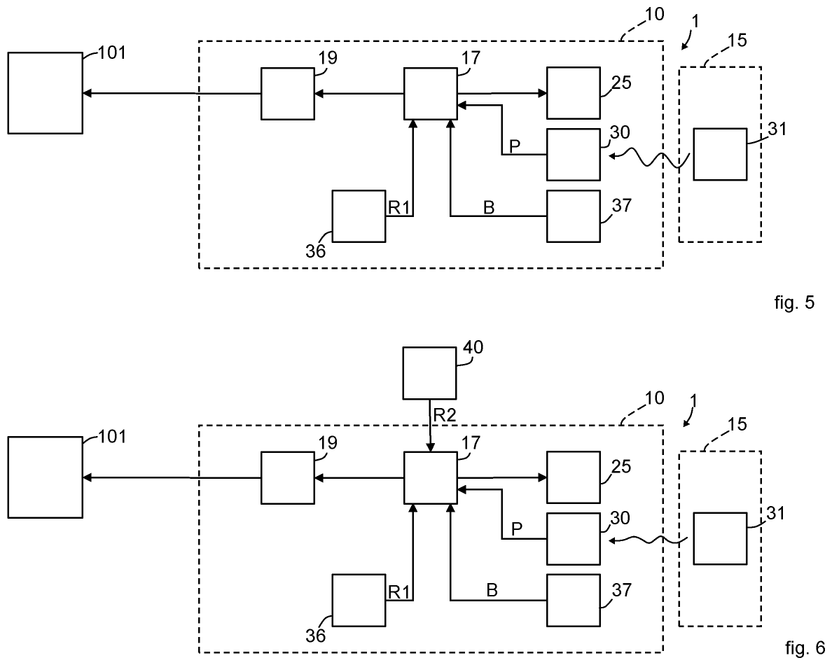

The safety switch 10 comprises a case 16 containing a control unit 17 (FIGS. 5, 6, 9 and 10) of electronic type and switching means 19, controlled by the control unit 17, which may turn between an active state and an inactive state distinguishable from each other and which are at a communication interface 20.

In this case, the switching means 19 comprise one or more safe outputs of the OSSD type, each of which may turns into at least one active state and one inactive state distinguishable from each other.

By way of example, a safe output in the active state transmits a signal and turns to a logical state equal to “1” or “ON” while in the inactive state it does not transmit any signal and turns into a logical state equal to “0” or “OFF”.

Even more preferably, the switching means 19 comprises at least two independent OSSD-type safe outputs.

The control unit 17 and the switching means 19 may be arranged on the same PCB or they may be arranged in respective PCBs physically separated and electrically connected to each other.

In other possible embodiments, the switching means 19 may also be of other known types and comprise electronic contacts of mechanical, electromechanical type, relay or any other electrical, electronic or electromechanical element suitable to selectively move from an active state wherein it allows the transmission of a signal and an inactive state wherein it does not allow the transmission of the signal.

Furthermore, the communication interface 20 is designed to transmit one or more signals associated with the state of the switching means 19 to one or more devices external to the safety switch 10. In particular, the communication interface 20 is designed to transmit at least one signal coding the state of the switching means 19.

By way of example, the communication interface 20 may comprise one or more connectors, or a communication BUS, for example of the IO-Link or ProfiSafe or ProfiNet type, or it may be of the wireless type, or any combination thereof.

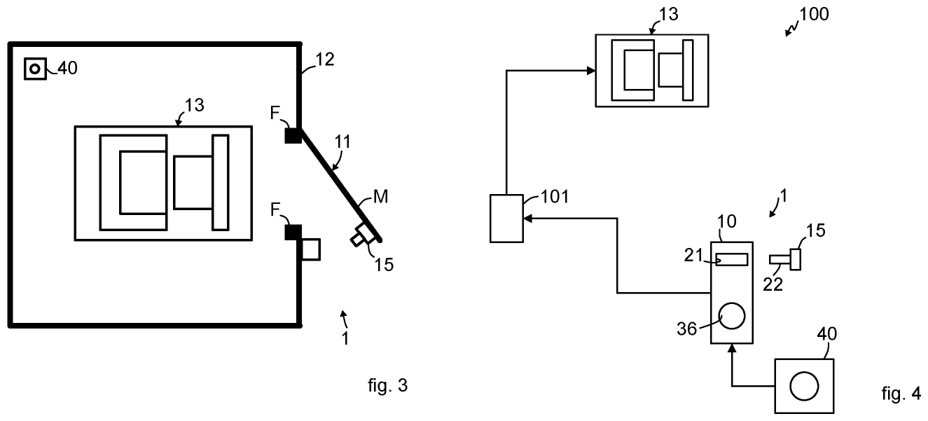

In use, the communication interface 20 may be connected, or linked, to a control device 101 (FIGS. 2 and 4 to 6) adapted to control the machine 13 on the basis of the signal associated with the state of the switching means 19. The control device 101 may comprise a PLC, or a safety module, or a contactor connected to the power supply of the machine 13, or similar devices or of the same kind, or any combination thereof. For example, if the state of the switching means 19 is inactive, the control device 101 does not allow the machine 13 to start.

The safety switch 10 also comprises a locking mechanism 25 (FIGS. 5, 6 and 9, 10) designed to selectively lock the actuator 15 in contact with the safety switch 10. In particular, the locking mechanism 25 is controlled by the control unit 17 and is designed to turn between a locked state wherein it keeps the actuator 15 at least in contact with the safety switch 10 and an unlocked state wherein the actuator 15 is not hold with respect to the safety switch 10 and may be moved away therefrom. For example, in the locked state the movable guard 11 cannot be opened while in the unlocked state the movable guard 11 may be opened.

In the present examples, with reference to FIGS. 7 to 10, the safety switch 10 also comprises a seat 21 for receiving at least one portion of the actuator 15. In particular, in these cases the actuator 15 comprises a driving pin 22 and the seat 21 is shaped to house at least part of the driving pin 22 at its inside.

Furthermore, the locking mechanism 25 is designed to selectively lock the driving pin 22 inside the seat 21. In particular, the locking mechanism 25 is arranged inside the case 16 and comprises a locking pin 26 and a moving member 27 controlled by the control unit 17 and designed to move the locking pin 26 between a locked position wherein it protrudes inside the seat 21 and an unlocked position wherein it is retracted towards the inside of the case 16 with respect to the locked position. The moving member 27 comprises, for example, an electromagnet controlled by the control unit 17 but may comprise any other member suitable for moving the locking pin 26 between the locked position and the unlocked position such as for example an electric motor, a pneumatic member or something else.

The locking pin 26 and the driving pin 22 are at least partially complementary shaped with each other so that the driving pin 22 cannot be extracted from the seat 21 when the locking pin 26 is in the locked position and may be extracted from the seat 21 when the locking pin 26 is in the unlocked position.

Furthermore, the safety switch 10 also comprises sensor means 29 for sensing the position of the locking pin 26 which are connected to the control unit 17 to communicate to the latter at least whether the locking pin 26 is in the locked position. By way of example, the sensor means 29 comprise one or more photoelectric barriers, each of which is positioned to be intercepted by a respective protruding part associated with the locking pin 26 when the latter is in the locked position. The person skilled in the art understands that the sensor means 29 may also be of any other known type, for example mechanical, electromechanical, electronic, magnetic and more.

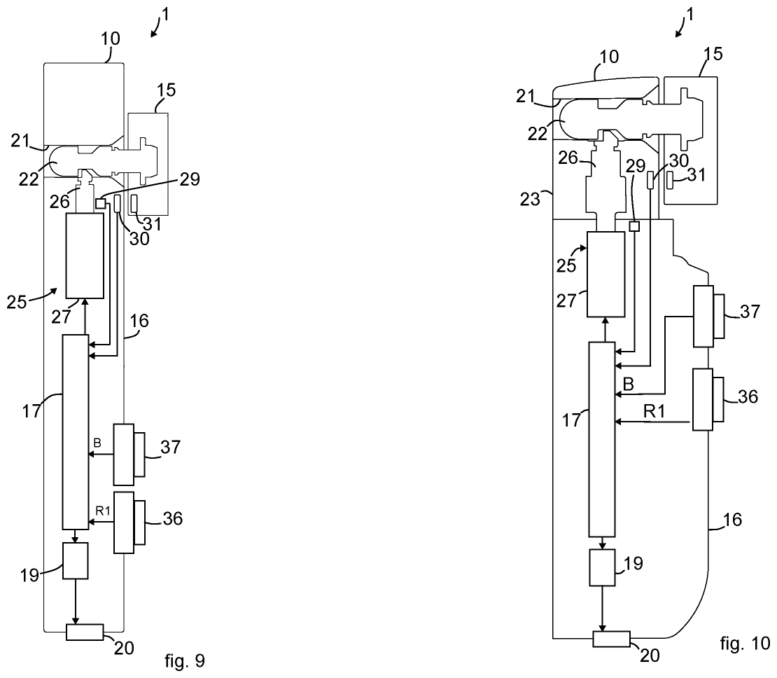

It should be noted that the seat 21 may be obtained directly on the case 16 (FIGS. 7 and 9) or on a head 23 (FIGS. 8 and 10) fixed to the case 16, for example at one end thereof.

In other embodiments, not shown in the figures, the safety switch 10 may be devoid of a seat for the actuator 15 and the locking mechanism 25 may be of the magnetic type and comprise an electromagnet controlled by the control unit 17. In these embodiments, the actuator 15 comprises a ferromagnetic clement adapted to interact with the electromagnet. In these cases, the control unit 17 is designed to move the locking mechanism 25 in the locked state by activating the electromagnet so as to block the ferromagnetic element in contact with the safety switch 10 and in the unlocked state by deactivating the electromagnet, so as to allow the ferromagnetic element to be moved away from the safety switch 10.

Optionally, the safety switch 10 and the actuator 15 comprise respective communication devices 30, 31 designed to interact remotely when the actuator 15 is close to the safety switch 10 and transmit a proximity signal P to the control unit 17. In particular, the safety switch 10 comprises a first communication device 30 and the actuator 15 comprises a second communication device 31 designed to interact remotely with the first communication device 30 when it is close thereof. The first communication device 30 is connected to the control unit 17 and is designed to transmit the proximity signal P thereto to signal that the actuator 15 is close to the safety switch 10.

By way of example, the first communication device 30 is an RFID antenna and the second communication device 31 is an RFID transponder. In this case, the RFID antenna is suitable for transmitting a signal suitable for exciting the RFID transponder when the latter is close to the RFID antenna. The RFID transponder, when excited by the RFID antenna, is also suitable for transmitting a response signal to the RFID antenna encoding a recognition code of the actuator 15. The RFID antenna is designed to receive the response signal transmitted by transponder and to transmit to the control unit 17 a proximity signal P associated with the recognition code of the actuator 15. This allows the control unit 17 to verify that only the correct actuator(s) 15 interact/s with the safety switch 10.

Furthermore, the proximity signal P allows the control unit 17 to detect that the movable guard 11 is closed. For example, when the locking mechanism is in the unlocked state and the control unit 17 receives the proximity signal P, the movable guard 11 is detected as close but not locked.

The safety switch 10 also comprises interaction means 36, 37 with the user connected to the control unit 17 to transmit an electrical signal thereto in response to an interaction with a user.

The interaction means comprise a main reset member 36 connected to the control unit 17 to transmit a main reset signal R1 thereto in response to an interaction with the user. By way of example, the main reset member 36 may be any member suitable to be handled by a user to transmit an electrical or electronic signal such as, for example, a button, a lever, a knob, a key or a screen touch-sensitive, or similar devices. Preferably, the main reset member 36 is fixed directly on the case 16 of the safety switch 10. Even more preferably, the main reset member 36 is a pushbutton fixed directly on the case 16 of the safety switch 10. In this case, in preferred embodiments, the main reset member 36 is a pushbutton fixed directly on the case 16 of the safety switch 10 designed to transmit to the control unit 17 the main reset signal R1 in response to a pressure followed by a release by the user. In this way, the physical separation between the safety switch and the main reset devices 36 is removed. Furthermore, safety is increased since to transmit the main reset R1, pressing the pushbutton by the user is not sufficient but this pressure must be followed by the release of the button.

Optionally, the interaction means for interaction with the user may also comprise a blocking member 37, also connected to the control unit 17 and designed to transmit a locking signal B thereto in response to an interaction with the user. In this case, the control unit 17 is also configured to recognize the locking signal B and command the locking mechanism 25 to move it into the locked state.

Preferably, the blocking member 37 is fixed directly on the case 16 of the safety switch 10.

However, the scope of the present invention also covers those embodiments wherein the safety switch 10 is connected to an external locking member and connected to the safety switch 10 via the communication interface 20 to transmit a locking signal.

In accordance with one aspect of the present invention, the control unit 17 is designed to move the switching means 19 into the active state when it receives, or has received, the main reset signal R1 and the actuator 15 is locked in contact with the safety switch 10.

In the present case, the control unit 17 is designed to move the switching means 19 into the active state when it receives, or has received, the main reset signal R1 and the actuator 15 is locked in the seat 21 by the locking mechanism 25.

Advantageously, the safety apparatus 1 of the present invention allows a high safety degree to be achieved while at the same time being cost-effective, compact and easy to install. As matter of fact, the direct integration of the main reset member 36 into the safety switch 10 allows, on the one side, to save space as no other human-machine interface separate from the safety switch 10 has to be associated with the movable guard 11, and, on the other side, also allows to reduce the installation time since the safety switch 10, being already equipped with the main reset member 36, has to be only connected to the control device 101. This also allows to reduce the number of operations requested for the installation of the safety apparatus 1 and, therefore, also the probability of human error. Furthermore, in this way the use of the safety apparatus 1 by the operator is made easier as there is no physical separation between the safety switch 10 and the main reset device 36.

In a first embodiment, the control unit 17 is designed to move the switching means 19 into the active state when the actuator 15 is locked in contact with the safety switch 10 and simultaneously receives the main reset signal R1.

For example, the control unit 17 is adapted to move the switching means 19 into the active state when the actuator 15 is inserted and locked into the seat 21 by the locking mechanism 25 and simultaneously receives a main reset signal R1. In these embodiments, the locking mechanism 25 may move from the unlocked state to the locked state before the transmission of the main reset signal R1, for example the control unit 17 receives the proximity signal P automatically or in response to the locking signal B.

In another embodiment, the control unit 17 is designed to move the switching means 19 into the active state when the actuator 15 is locked in contact with the safety switch 10 following reception of the main reset signal R1.

For example, the control unit 17 is designed to move the switching means 19 into the active state when the actuator 15 is locked in the seat 21 by the locking mechanism 25 after receiving the main reset signal R1. In these embodiments, the locking mechanism 25 switches from the unlocked state to the locked state in response to the locking signal B transmitted by the blocking member 37.

In some embodiments, the safety apparatus 1 also comprises an auxiliary reset device 40 distinct and separate from the safety switch 10 and operable by an operator. The auxiliary reset device 40 is, for example, a pushbutton on a pushbutton panel separated and distinct from the safety switch 10. Preferably, in use, the auxiliary reset device 40 is arranged inside the mechanical barrier 12. The second reset device 40 is connected to the control unit 17 of the safety switch 10 and is designed to transmit thereto an auxiliary reset signal R2 in response to an interaction with the operator.

In these cases, the control unit 17 is designed to move the switching means 19 into the active state when it receives, or has received, the main R1 and auxiliary R2 reset signals and the actuator 15 is held in contact with the safety switch 10.

Preferably, the control unit 17 is designed to move the switching means 19 into the active state only if it receives the auxiliary reset signal R2 prior to the main reset signal R1. Furthermore, the control unit 17 may also be designed to detect the time interval t that elapses between the reception of the auxiliary reset signal R2 and the main reset signal R1 and to compare said time interval t with a predetermined threshold t1. In these cases, the control unit 17 is designed to move the switching means 19 into the active state when the time interval t is less than the predetermined threshold t1 and the actuator 15 is locked in contact with the safety switch 10 by the locking mechanism 25.

The present invention also refers to a safety system 100 comprising a machine 13 surrounded at least partially by a mechanical protection barrier 12 having a movable guard 11 provided with a fixed part F and a movable part M. The safety system 100 comprises also a safety apparatus 1 according to the present invention associated with the movable guard 11 and a control device 101 connected to the safety apparatus 1 and designed to allow or not allow the operation of the machine 13 as function of the state of the switching means 19.

The safety switch 10 is connected to the control device 101 via the communication interface 20 which is designed to transmit to the control device 101 a control signal associated with the state of the switching means 19.

The control device 101 is designed to allow or not the operation of the machine 13 as function of the signal associated with the state of the switching means 19 transmitted by the safety switch 10. Preferably, the control device 101 is designed to allow the operation of the machine 13 if the switching means 19 are in the active state.

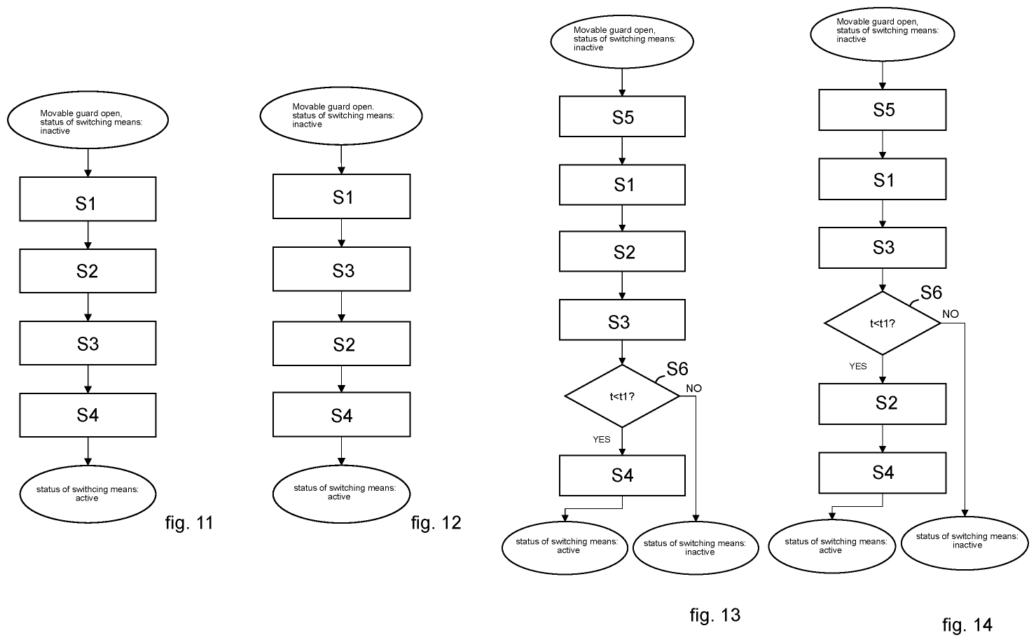

With reference to FIGS. 11 to 14, the present invention also refers to a safety process for controlling access to a dangerous area guarded by the safety equipment 1 described above.

The process involves a closing step S1 of the movable guard 11 wherein the actuator 15 is moved close to the safety switch 10 and interacts therewith and a locking step S2 wherein the locking mechanism 25 turns into said locked state by locking the actuator 15 in contact with the safety switch 10.

During the closing step S1, the control unit 17 receives the proximity signal P generated in response to the recognition of the second communication device 31 by the first communication device 30.

During the locking step S2 the control unit 17 controls the locking mechanism 25 to make it move from the unlocked state to the locked state wherein it locks the actuator 15 in contact with the safety switch 10. The locking step S2 may be triggered by operating the blocking member 37 integrated in the safety switch 10 or via any other blocking member external to the safety switch 10 or it can occur automatically.

The process also comprises a main reset step S3 wherein the main reset member 36 transmits the main reset signal R1 to the control unit 17.

Furthermore, the method provides a switching step S4 wherein the switching means 19 turns into the active state. During the switching step S4, the control unit 17 controls the switching means 19 to move them into the active state.

It should be noted that the switching step S4 occurs only after the main reset step R1 and the locking step S2.

In particular, the control unit 17, to move the switching means 19 into the active state, must have received at least the main reset signal R1 and detected that the actuator 15 is locked in contact with the safety switch 10 by the locking mechanism 25.

The locking step S2 may occur prior to the main reset step S3 (FIG. 11 or 13) or subsequently (FIG. 12 or 14) to the main reset step S3 without departing from the scope of protection of the present invention.

With reference to FIGS. 13 and 14, in some embodiments the process of the present invention also provides an auxiliary reset step S5 wherein the auxiliary reset member 40 transmits the auxiliary reset signal R2 to the control unit 17. In these embodiments, the auxiliary reset step S5 occurs prior to the locking step S2 and the main reset step S3.

Furthermore, in these embodiments the method provides a processing step S6, following the main reset step S3, wherein the control unit 17 detects the time interval t elapsed between the reception of the auxiliary reset signal R2 and of the main reset signal R1 and compares it with a predetermined threshold t1. Therefore, only if the time interval t is less than the predetermined threshold t1 and the locking step S2 has been carried out, the control unit 17 carries out the switching step S4 wherein it controls the switching means 19 to move them into the active state. Instead, if the time elapsed between the reception of the auxiliary reset signal R2 and the main reset signal R1 is greater than the predetermined threshold, the control unit 17 holds the switching means in the inactive state.

1. Safety apparatus comprising a safety switch (10) and an actuator (15) designed to be associated with a movable guard (11) and to interact with each other upon opening and closing of said movable guard (11), wherein said safety switch (10) comprises:
switching means (19) designed to turn between an active state and an inactive state;
a locking mechanism (25) designed to turn between a locked state wherein it locks said actuator (15) in contact with said safety switch (10) and an unlocked state wherein it allows the removal of said actuator (15) from said safety switch (10);
a control unit (17) connected to said locking mechanism (25) to detect the state thereof and to said switching means (19) and to control said switching means (19);
wherein said safety switch (17) further comprises a main reset device (36) connected to said control unit (17) and adapted to be operated by an operator and designed to transmit a main reset signal (R1) to said control unit (17);
wherein said control unit (17) is designed to move said switching means (19) into said active state when said control unit (17) has received at least said main reset signal (R1) and said actuator (15) is locked in contact with said safety switch (10).

2. The safety apparatus of claim 1, further comprising an auxiliary reset device (40) separated from said safety switch (10) and adapted to be operated by an operator, said auxiliary reset device (40) being connected to said control unit (17) and designed to transmit an auxiliary reset signal (R2) to said control unit (17).

3. The safety apparatus of claim 2, wherein said control unit (17) is designed to move said switching means (19) into said active state when said control unit (17) has received said main reset signals (R1) and said and auxiliary reset signals (R2) and said actuator (15) is locked in contact with said safety switch (10).

4. The safety apparatus as claimed in claim 1, wherein said safety switch (10) comprises a seat (21) suitable for receiving inside it at least one portion of said actuator (15) and wherein said locking mechanism (25) comprises a locking pin (26) movable between a locked position wherein said locking pin (26) locks the at least one portion of said actuator (15) in said seat (21) and an unlocked position wherein said locking pin (26) allows the extraction of said actuator (15) from said seat (21).

5. The safety apparatus of claim 1, wherein said safety switch (10) further comprises a blocking member (37) adapted to be operated by a user and designed to transmit a locking signal (B) to said control unit (17), said control unit (17) being designed to move said locking mechanism (25) into said locked state in response to said locking signal (B).

6. The safety apparatus of claim 1, wherein said safety switch (10) comprises a first communication device (30) and said actuator (15) comprises a second communication device (31) designed to interact remotely with said first communication device (30) when said second communication device (31) is close to said first communication device (30), said first communication device (30) being connected to said control unit (17) and designed to transmit thereto a proximity signal (P) of said actuator (25).

7. The safety apparatus of claim 2, wherein said control unit (17) is designed to detect the time interval (t) elapsed between the reception of said auxiliary reset signal (R2) and said main reset signal (R1), to compare said time interval (t) with a predetermined threshold (t1) and to move said switching means (19) into said active state when said time interval (t) is lower than said predetermined threshold (t1) and said actuator (15) is locked in contact with said safety switch (10).

8. The safety apparatus of claim 1, wherein said safety switch (10) comprises a case (16) containing at least said control unit (17) and said switching means (19) and wherein said main reset member (36) is a pushbutton fixed directly on said case (16).

9. The safety apparatus of claim 1, wherein said pushbutton is designed to transmit to said control unit (17) said main reset signal (R1) in response to a pressure of said pushbutton followed by the release of said pushbutton by the user.

10. Safety system comprising a machine (13) and a control device (101) connected to said machine (13) and designed to allow or not allow its operation, further comprising a safety apparatus (10) according to claim 1 connected to said control device (101) and designed to transmit thereto a signal associated with the state of said switching means (19), wherein said control device (101) is designed to allow or not the operation of said machine as function of said signal associated with the state of said switching means (19).

11. Safety process for controlling the access to a hazard area guarded by a safety apparatus (1) according to claim 1, wherein said process comprises:
a closing step (S1) of said movable guard (11) wherein said actuator (15) is moved close to said safety switch (10);
a locking step (S2) wherein said locking mechanism (25) move to said locked state wherein it locks said actuator (15) in contact with said safety switch (10);
a main reset step (S3) wherein said main reset member (R1) transmits said main reset signal (R1) to said control unit (17);
a switching step (S4) wherein said control unit (17) moves said switching means (19) into said active state when it has received at least said main reset signal (R1) and said actuator (15) is locked into contact with said safety switch (10).

12. The safety process of claim 11, wherein said locking step (S2) occurs prior to said main reset step (S3).

13. The safety process of claim claim 11, wherein said locking step (S2) occurs after said main reset step (S3).

14. The safety process of claim 11, wherein said safety apparatus (1) further comprises an auxiliary reset device (40) separated from said safety switch (10) and adapted to be operated by an operator, said auxiliary reset device (40) being connected to said control unit (17) and designed to transmit an auxiliary reset signal (R2) to said control unit (17), wherein an auxiliary reset step (S5) is further provided, preceding said main reset step (S3) and said locking step (S2), wherein said auxiliary reset member (40) transmits said auxiliary reset signal (R2) to said control unit (17).

15. The safety process of claim 14, comprising a processing step (S6) wherein said control unit (17) detects the time interval (t) elapsed between the reception of said auxiliary reset signal (R2) and said main reset signal (R1) and compares it with a predetermined threshold (t1).

16. The safety process of claim 15, wherein said switching step (S4) occurs only if said time interval (t) is lower than said predetermined threshold (t1) and said locking mechanism (25) is in said locked state.
